(19) United States
(12) Patent Application Publication
(10) Pub. No.: US 2010/0017232 A1
(43) Pub. Date: Jan. 21, 2010

(54) Information Transmittal And Notification System

(75) Inventors: Steven Brian Spedale, Baton Rouge, LA (US); Dale Edward Baker, JR., Baton Rouge, LA (US)

Correspondence Address: McGLINCHEY STAFFORD, PLLC;Attn: IP Group, 301 Main Street, 14th Floor, BATON ROUGE, LA, 70802, US

(73) Assignee: StevenDale Software, LLC, Baton Rouge, LA (US)

(21) Appl. No.: 12/506,084

(22) Filed: Jul. 20, 2009

Related U.S. Application Data
(60) Provisional application No. 61/082,086, filed on Jul. 18, 2008.

(51) Int. Cl. G06Q 50/00; H04L 9/32; G05B 19/00

(52) U.S. Cl. 705/3; 705/2; 726/5; 340/5.82; 707/104.1

(57) ABSTRACT

One embodiment of this invention is an automated information transmittal system including a first database component operative to receive and maintain at least one medical data parameter, a processor programmed to detect the medical data parameter and to compare the medical data parameter to a configured set of instructions, and a primary transmitter component operative to transmit a first signal to a portable electronic device if the medical data parameter satisfies the configured set of instructions, wherein a user of the portable electronic device may review the medical data parameter by accessing a remote application from the portable electronic device. The system further includes a portable electronic device transmitter component operative to transmit at least a second signal from the portable electronic device, the second signal generated upon input from the user and transmitted to at least a first output device in a remote location, an authentication component operative to acknowledge the second signal received by the first output device, and a second database component operative to receive and maintain authentication and transmittal information generated by the authentication component, the portable electronic device and/or the first output device.

### REFERENCE TO RELATED APPLICATIONS

This Application claims the benefit of prior co-pending U.S. Provisional Application No. 61/082,086, filed Jul. 18, 2008, the disclosure of which is incorporated herein by reference.

### TECHNICAL FIELD

This invention relates to an information transmittal and notification system, more particularly, an information transmittal and notification system using portable electronic devices.

### THE INVENTION

This invention provides in at least one embodiment an information transmittal and notification system that provides a novel and efficient manner for enhancing the transmission of information for notification purposes. Although this system is capable of different applications in various industries, this system is particularly helpful in the practice of medicine by allowing information to be passed from remote facilities to health care facilities. In particular, this system provides a solution to the need for accurate and rapid transmission of laboratory results and accompanying physician's orders based on such results, especially when the laboratory results are critical to determining treatments for critically ill patients.

One embodiment of this invention is an automated information transmittal and notification system comprising a first database component operative to receive and maintain at least one medical data parameter, a processor programmed to detect the medical data parameter and to compare the medical data parameter to a configured set of instructions, and a primary transmitter component operative to transmit a first signal to a portable electronic device if the medical data parameter satisfies the configured set of instructions, wherein a user of the portable electronic device may review the data parameter by accessing a remote application from the portable electronic device. The system further comprises a portable electronic device transmitter component operative to transmit at least a second signal from the portable electronic device, the second signal generated upon input from the user and transmitted to at least a first output device in a remote location, an authentication component operative to acknowledge the second signal received by the first output device, and a second database component operative to receive and maintain authentication and transmittal information generated by the authentication component, the portable electronic device and/or the first output device.

Another embodiment of this invention is a transmittal and notification system for medical events comprising a primary database component for receiving at least one medical event from a remote facility, a processor for scanning the primary database for the medical event and comparing the medical event to a preconfigured set of logic decisions, and a primary transmittal component operative to transmit a primary signal to a portable electronic device depending on a satisfactory relationship between the medical event and the preconfigured set of logic instructions, the primary signal directing a health care professional observing the portable electronic device to a remote application on the portable electronic device where the health care professional may interpret the medical event. The system further comprises a portable electronic device transmittal component operative to transmit at least a secondary signal generated upon input from the health care professional from the portable electronic device to at least a first output device in a health care facility, an authentication component operative to indicate that a health care worker in the health care facility has received the secondary signal, and a secondary database component operative to store at least one record of the authentication of the secondary signal and transmission of the medical event generated by the authentication component, the portable electronic device and/or the first output device.

Still another embodiment comprises a computerized method for transmitting information and the authentication of the transmission of information, the method comprising receiving at least one medical data parameter from at least one remote medical facility, storing the medical data parameter in a first database component, and comparing the medical data parameter to a set of preconfigured set of instructions. The method further comprises transmitting a first signal to a portable electronic device if the medical data parameter satisfies the preconfigured set of instructions, the first signal when received by the portable electronic device providing an access point to a remote application, whereby a user of the portable electronic device may review the medical data parameter, transmitting at least a second signal from the portable electronic device, the second signal generated upon input from the user of the portable electronic device and transmitted to at least a first output device, authenticating by an authentication component the reception of the second signal by the first output device, and storing in a second database component the authentication and transmittal information generated by the authentication component, the portable electronic device and/or the first output device, whereby the authentication and transmittal information may be reviewed to ensure proper transmission of the transmittal information.

These and other features of this invention will be still further apparent from the ensuing description, drawings, and appended claims.

### BRIEF DESCRIPTION OF THE DRAWINGS

FIG. 1 is a flow diagram of a system consistent with one embodiment of the present invention.

FIG. 2 illustrates an alphanumeric display screen of a light box monitoring system consistent with one embodiment of the present invention.

FIG. 3 illustrates an alphanumeric display screen of an email generated from a primary signal consistent with one embodiment of the present invention.

FIG. 4 illustrates an alphanumeric display screen of a medical event accessed in a remote application consistent with one embodiment of the present invention.

FIG. 5 illustrates printed characters generated by a secondary signal consistent with one embodiment of the present invention.

FIG. 6 illustrates printed characters generated by a secondary signal consistent with an alternate embodiment of the present invention.

FIG. 7 illustrates an alphanumeric display screen of an email generated by a signal consistent with an alternate embodiment of the present invention.

FIG. 8 illustrates an alphanumeric display screen of an email generated by a signal consistent with an alternate embodiment of the present invention.

FIG. 9 illustrates an alphanumeric display screen of an email generated by a signal consistent with an alternate embodiment of the present invention.

FIG. 10 illustrates software code consistent with one embodiment of the present invention.

In each of the above figures, like numerals are used to refer to like or functionally like parts among the several figures.

### FURTHER DETAILED DESCRIPTION OF THE INVENTION

Illustrative embodiments of the invention are described below as they might be employed in the construction and use of an information transmittal and notification system and method according to the present invention. In the interest of clarity, not all features of an actual implementation are described in this specification. It will be of course appreciated that in the development of such an actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

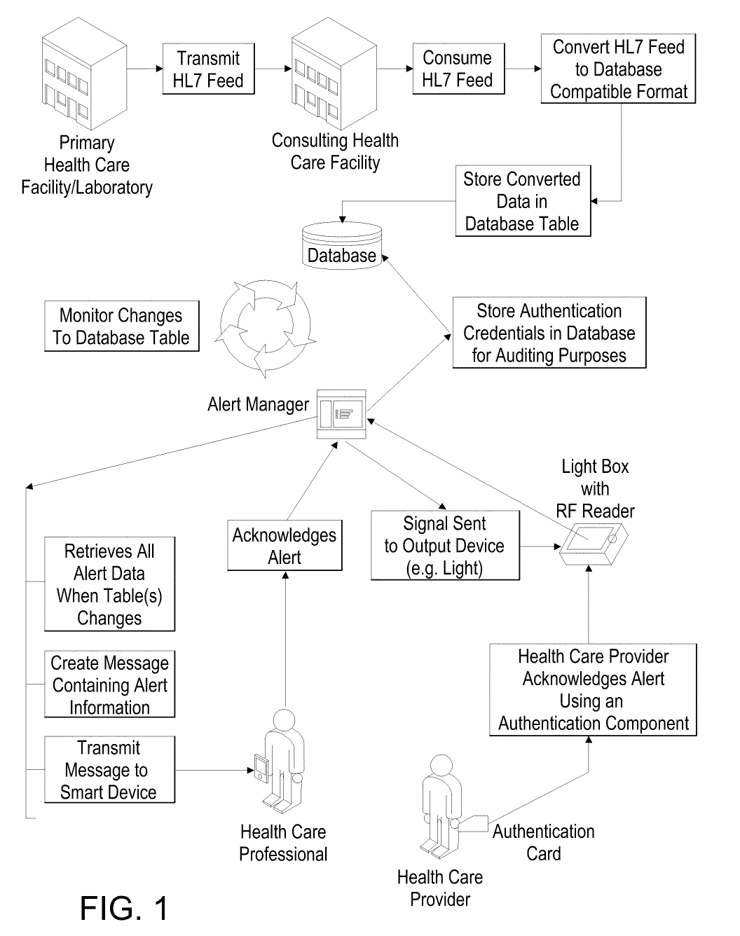

Turning now to the figures, FIG. 1 illustrates an automatic information transmittal and notification system consistent with one embodiment of the present invention. In this embodiment, a medical data parameter, such as a medical laboratory result, is produced at a remote facility, illustrated in FIG. 1 as a primary health care facility or medical laboratory. The health care facility transmits the laboratory results in HL7 format, a data format universally adopted by the health care industry, to a consulting health care facility. The consulting health care facility may be for example, a physician's office, hospital, or any other health care facility in electronic communication with the laboratory. In this embodiment, the laboratory results are transmitted to a physician's office located in a hospital.

Upon receiving the laboratory results in HL7 data format in the physician's office, the results are converted, e.g., by COREPOINT INTEGRATION ENGINE™ formerly known as NEOINTEGRATE™, developed by COREPOINT HEALTH™ formerly known as NEOTOOL®, of Plano, Tex., from a HL7 format to a database-compatible format and stored in a laboratory table in a first database component, illustrated as a database in FIG. 1. This database component may be any database commercially available so long as it is operative to receive and maintain at least one data parameter. In this particular illustrated embodiment, there are a plurality of data parameters comprising medical laboratory test results. Those skilled in the art will understand that the database component may be just a portion of a larger database or table or may be a distinct database or table related to other distinct databases or tables. The database-compatible format may, e.g., be standard text. In an alternative, the HL7 data may be manually converted and input into the laboratory table in the database.

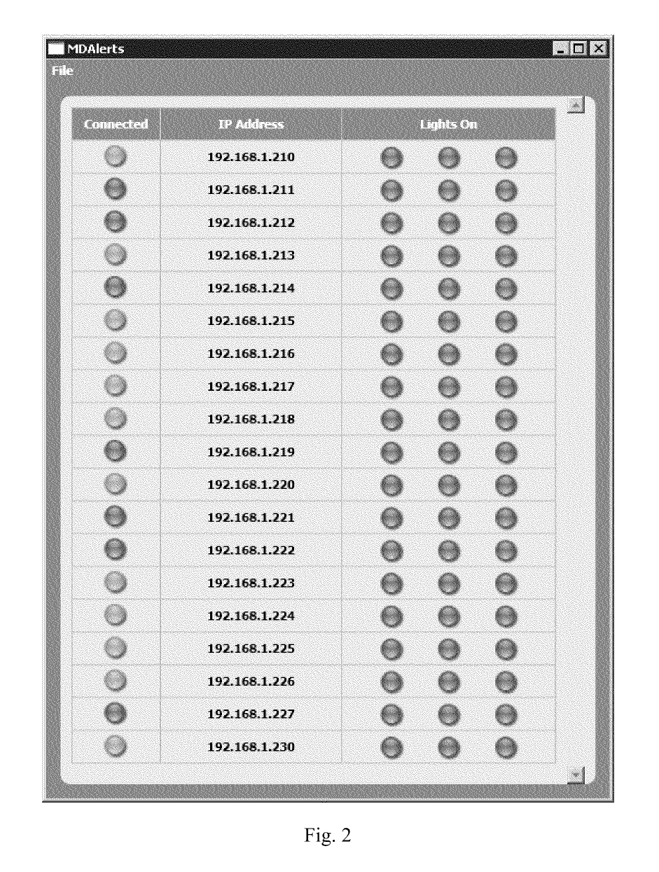

As shown in FIG. 1, the laboratory results are stored in a database. A processor is programmed to detect a change in the database, generally found when a new laboratory result is added to the database. In this embodiment, a Microsoft Windows® client application programmed using C# is used to monitor the database and to detect changes to the laboratory tables in the database. This application is illustrated generally as the Alert Manager in FIG. 1. FIG. 2 illustrates a display screen showing the monitoring and activation of the individual light sources, discussed further below. Once a change is detected in the database, the new laboratory results are retrieved from the laboratory table and compared to a set of preconfigured set of instructions, typically based on a rules engine. This rules engine determines if a notification or message should be composed. The rules engine may be configured to compose a notification when a certain criterion is met or may be configured to generate a notification when a certain criterion is missing from the laboratory results. Further, the preconfigured set of instructions may include, for example, instructions to compose a notification including all changes to the laboratory table to be included in the notification.

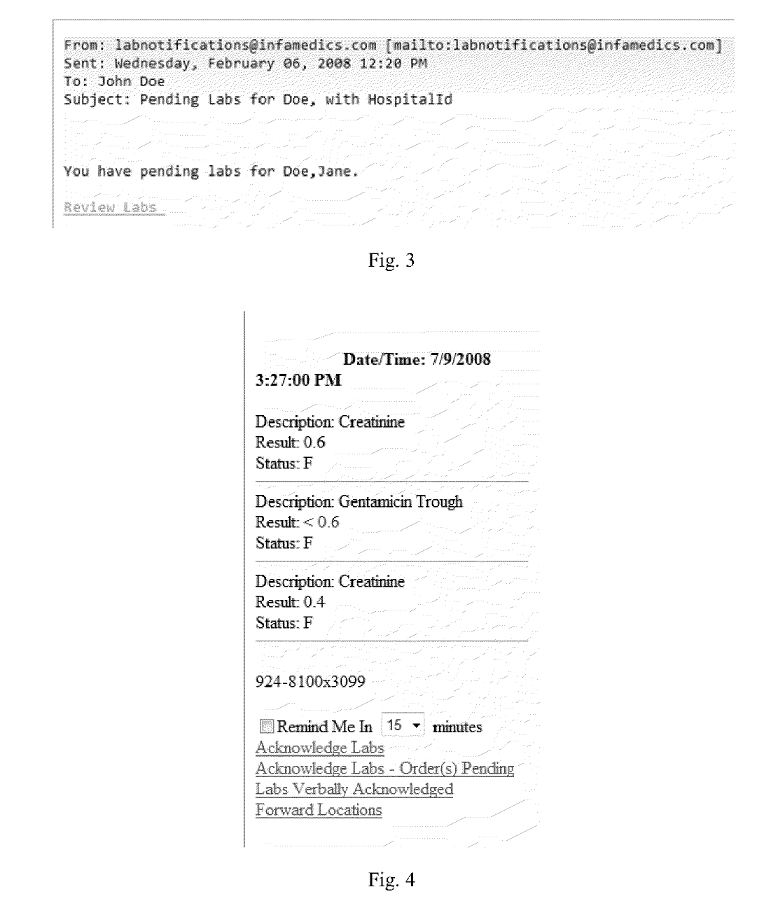

Once the laboratory results are compared to the rules engine and it is determined that the criteria is met for the generation of a notification, which in this embodiment is an email, a primary transmitter component is used to transmit a first signal to a portable electronic device. As stated above, the notification may be generated depending on the preconfigured set of instructions. Thus, for example, the first signal may include medical data comprising an abnormal test result where the test result is outside of a pre-defined range configured in the instructions. Optionally, the first signal may include entire laboratory results if such instructions were included in the rules engine. The first signal in this embodiment is an email transmitted over a wired or wireless network. The primary transmitter component may be any device capable of transmitting the email to the portable electronic device. Typically, such a device may be a modem. The email is sent to the portable electronic device, typically referred to as a smart device, of a health care professional assigned to the patient to whom the lab results are associated. The smart device may be a pager, a PDA, or a smart phone (e.g., BLACKBERRY®). FIG. 3 illustrates an email sent to the smart phone of a health care professional notifying the professional of the results of a laboratory test. The health care professional is a medical doctor in this embodiment, but may be any licensed health care professional qualified to interpret laboratory results and suggest treatments associated with the results.

The health care professional may review the laboratory results by accessing a remote application from the smart phone. The remote application may be any such application that would allow the health care professional to view the email on the portable electronic device, including, for example, any commercial email server. As illustrated in FIG. 3, the email may include a hyperlink in HTML format directing the health care professional to the laboratory results by using a web application on the smart phone. This web application allows the health care professional to view the laboratory results. In this embodiment, the hyperlink reads “Review Labs,” but it should be appreciated that alternate hyperlink labels may be used to direct the health care professional to the laboratory results. FIG. 4 illustrates the format of the laboratory results viewed in the web application on the smart phone. As shown, the components of the laboratory results may be shown on the smart phone display screen in conjunction with a plurality of hyperlinks at the bottom of the display screen. These hyperlinks provide the health care professional with a variety of choices in how to proceed in treating the patient associated with the respective laboratory results.

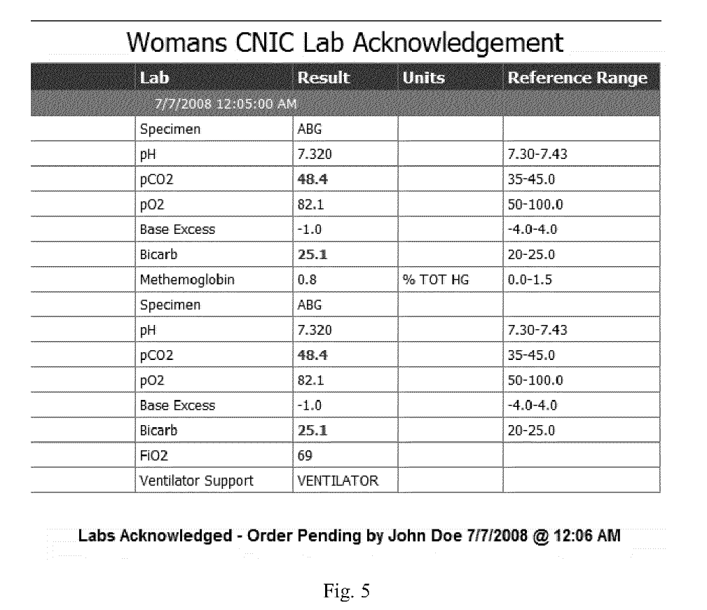

As shown in FIG. 4, one of the hyperlinks may read “Acknowledge Labs.” This hyperlink, when activated by “clicking on” or accessing the hyperlink, marks the laboratory result as acknowledged in the laboratory table in the database and is electronically connected to a portable electronic device transmitter component operative to transmit at least a second signal from the portable electronic device. Optionally, the portable electronic device transmitter component is operative to transmit a third signal in addition to the second signal. In one embodiment, by clicking on the aforementioned hyperlink, the health care professional will generate two signals that will be transmitted by the smart phone. One of these signals, referred to above as a second signal, will be transmitted to a first output device and the other signal, referred to above as a third signal, will be transmitted to a second output device. Multiple signals and output devices may be used in the system; however, it should be appreciated that the system will include at least one signal transmitted to at least one output device. These output devices may be located in a remote location. In this embodiment, the remote location is proximate to the bedside of the patient to whom the lab results are associated. However, it should be appreciated that the remote location may be a nurses' station or other location in a health care facility. In one embodiment, the first output device is a printer, specifically the printer assigned to the patient's location. FIG. 5 illustrates the results of the second signal transmitted to the printer, wherein the “Acknowledge Labs” hyperlink of FIG. 4 is activated and the laboratory results for the associated patient are printed on a paper medium in such a manner that the results may be discerned and easily comprehended by a health care provider at the bedside of the patient. In addition to the second signal transmitted to the printer, the third signal is transmitted to the second output device, wherein the second output device is a visual or audio indicator, illustrated in FIG. 1 as a light box comprising at least one light in this embodiment.

The light box may contain four or more phone line inputs, a CAT-5 network input, and a HID RF reader. The phone line inputs power may be turned on or off by sending text commands over a socket connection using the IP address assigned to the light box. In the illustrated embodiment, the program sending the text commands is run on a PICOFLASH 186 microtroller board manufactured by JK Microsystems of Davis, Calif. The program may be compiled with Borland C++ IDE 4.52. The power from the phone line inputs is used to power the light in the light box. As stated, the light box comprises one or more lights. The light may be a PATLITE® Signal Tower Light, from the PATLITE® Corporation, which may be powered using a standard phone line. The light boxes containing the lights are mounted proximate to one or more patient locations. It should be appreciated that other light sources of course may be used, including for example LEDs and the like.

In an alternate embodiment, other output devices may be employed. One such output device may be, e.g., a computer, typically a personal computer in the form of a desktop or laptop computer. Typically, the personal computer will be located adjacent the bedside of the patient to which the laboratory result is linked. Another output device employed may be a handheld wireless device. Such handheld wireless devices may include, for example, pagers, PDAs, and other “smart” devices including smart phones such as BLACKBERRY® phones, IPHONE® phones, etc. These devices may be carried by the health care providers who are, generally speaking, any individual qualified to administer care to the patient associated with the laboratory results. Such individuals may include, e.g., nurses, technicians, therapists, physician assistants, physicians and the like.

As stated, in one embodiment, a signal is generated by the portable electronic device upon input from the health care professional to the light box thereby activating the light and causing it to emit light. The light may be emitted continuously or may be pulsed in order to produce a flashing or strobe-like effect. The light may serve as a visual indicator that a particular lab result and/or instruction has become available for the associated patient. In addition to the “Acknowledge Labs” hyperlink, an additional feature may be found in FIG. 4 above the aforementioned hyperlink. The health care professional has the option of checking a box with the amount of time selected in order to receive a reminder regarding the laboratory result if he or she is unable to review the results at that particular moment.

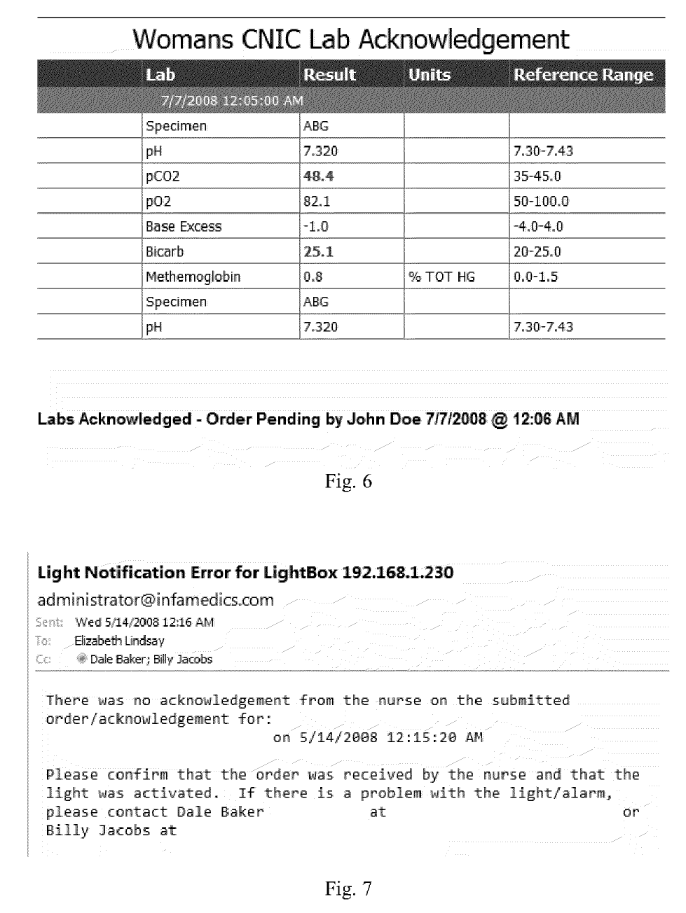

As illustrated in FIG. 4, a hyperlink labeled “Acknowledge Labs—Order(s) Pending” is presented as another option available to the health care professional upon reviewing the laboratory results. If the health care professional activates this hyperlink, the laboratory results are marked as acknowledged in the laboratory table in the database and then the smart phone transmits a signal containing the laboratory results and an accompanying order to the health care provider at the patient's bedside pertaining to the laboratory results. This signal may be received by a printer located proximate to the patient's bedside. FIG. 6 illustrates laboratory results and an accompanying order received by the printer. An additional signal is transmitted from the smart phone to the light box, thereby activating at least one light, providing a visual indicator that a laboratory result and accompanying order has been received.

Shown in FIG. 4 is an alternate hyperlink labeled “Labs Verbally Acknowledged” as an option when receiving the laboratory results on the smart phone. Activating this hyperlink marks the laboratory results as acknowledged in the laboratory table of the database; however, no additional signals are sent to an output device. The health care professional may choose to verbally communicate the acknowledgement of the laboratory results and/or convey orders relating to treatment based on the laboratory results directly to the health care providers at the health care facility. The health care professional may verbally communicate the acknowledgement and/or orders by calling the health care providers from his or her smart phone or in person if the health care professional is at the health care facility when he receives the laboratory results on his or her smart phone.

FIG. 4 illustrates a final hyperlink labeled “Forward Locations” that serves as the final option the health care professional has upon receipt of the laboratory results. Activating this hyperlink allows the health care professional to transfer all of his or her assigned patient locations to another health care professional. This option allows the health care professional to transfer the patient locations to another health care professional in case of emergencies or any other cases where the health care professional may not be able to respond to the laboratory results.

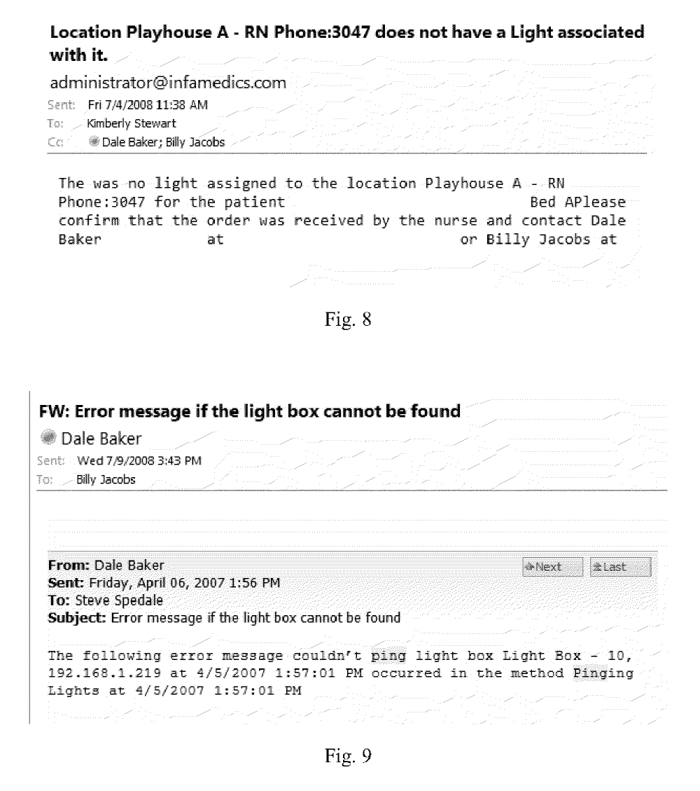

In an embodiment comprising the light box, the system further comprises an assignment signal, wherein the assignment signal will be sent to the smart phone of the health care professional if the patient's location does not have a light box. The assignment signal in this embodiment may be an email sent to the smart phone of the health care professional as illustrated in FIG. 8. This email may only be generated if the health care professional activated the hyperlink “Acknowledge Labs” or “Acknowledge Labs—Order(s) Pending” and a light box is not located proximate to the assigned patient's location. In addition, the first signal sent to the smart phone, as an email illustrated in FIG. 3, may be resent to the health care professional if he or she has not acknowledged the receipt of the laboratory results on his or her smart phone within a configured amount of time.

In at least one embodiment, the system further comprises a test signal sent to the light box, wherein once the health care professional activates either the hyperlink “Acknowledge Labs” or “Acknowledge Labs—Order(s) Pending,” the test signal is transmitted to the light box to confirm the presence of a light box at the patient's location. If the test signal is unable to verify that a light box is present at the patient's location, a test result signal, in the form of an email, is sent to the smart phone of the health care professional notifying him or her that the light box at the specified IP address could not be verified. An example of an email consistent with one embodiment of the present invention is found in FIG. 9.

As illustrated in the embodiment of FIG. 1, the system further comprises an authentication component, wherein the authentication component comprises a radio frequency transmitter illustrated as an ID card or badge and the radio frequency receiver illustrated as an ID card or badge reader located on the light box. Although the card reader is located on the light box in this embodiment, the card reader may be located proximate to another output device, e.g., the printer or computer, and/or the patient's bedside. Depending on the number and type of output devices, there may be a plurality of card readers. There may be one card reader for each output device or a plurality of output devices may communicate with one card reader. It should be noted that, as used throughout this specification and the appended claims, the term authentication component may include a single component or multiple components each of which enable authentication to an associated, respective device. In one example, the RF transmitter and receiver associated with the card reader is operative to acknowledge the second and third signal received by the respective output device, wherein the second signal is the signal sent to the printer as illustrated in FIGS. 4 and 5 and the third signal is the signal sent to the light box. Upon the health care provider receiving the notification from the light and print-out of the laboratory results and/or orders from the health care professional from the printer, the health care provider removes the orders and/or laboratory results from the printer and swipes his or her RF ID card in or proximate to the RF receiver on the light box. Swiping the ID card across the receiver causes the light to be deactivated and updates the light notification request in the database to complete. The badge number of the badge swiped is also assigned to the completed notification. In at least one embodiment, a acknowledgement signal, in the form of an email, is sent to the smart phone of the health care professional if the health care provider does not swipe his or her card to deactivate the light and acknowledge receipt of the laboratory results in a configured amount of time. An email consistent with one embodiment of the present invention is illustrated in FIG. 7.

It should be appreciated that an authentication component may include, e.g., a biometric device. Such biometric devices may include, e.g., fingerprint scanners, iris scanners, face recognition systems, and the like. Optionally, in embodiments where there are two or more authentication components, at least one authentication component may be a biometric reader and at least one authentication component may be a RF transmitter and receiver. In the alternative, other authentication components known to those of skill in the art may be practiced also. For example, entering a pass code or other identifying string of characters into a keypad or touch screen associated with the output device may be employed as an authentication component.

As shown in the embodiment of FIG. 1, a second database component operative to maintain a database identifying authentication and transmittal information is illustrated as the database. The database stores information regarding, for example, who created the notification, which patient the notification was for, which location it was sent to, and who received the notification and the date and time of each event. Optionally, the database may store the information transmitted to the health care provider, e.g., laboratory results and orders from the health care professional.

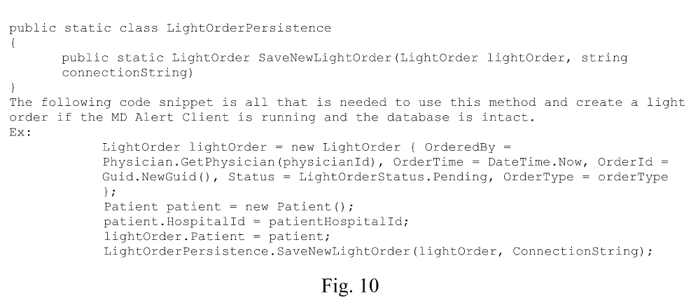

Although the information notification system may be initiated automatically based on the laboratory results received in HL7 format, an alternate embodiment of the present invention allows for the notification of the laboratory results. In an alternate embodiment, the transmittal and notification system may be initiated from a client application that references the notification system. The transmittal and notification system is a dynamically linked library and can be referenced in any .Net application or win32 application using COM (Component Object Model) Interop. In one embodiment, to create a new light order in an application that references the dynamically linked library, the method shown in FIG. 10 within the following class can be called. If the client is running it will detect this insert and turn on the lights.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent or other publication or published document referred to in any portion of this specification is incorporated in toto into this disclosure by reference, as if fully set forth herein.

This invention is susceptible to considerable variation within the spirit and scope of the appended claims.

1. An automated information transmittal and notification system comprising:
a first database component operative to receive and maintain at least one medical data parameter specific to a given patient;
a processor programmed to detect the data parameter and to compare the medical data parameter to a configured set of instructions;
a primary transmitter component operative to transmit a first signal to a portable electronic device if the medical data parameter satisfies the configured set of instructions, wherein a user of the portable electronic device may review the medical data parameter by accessing a remote application from the portable electronic device;
a portable electronic device transmitter component operative to transmit at least a second signal from the portable electronic device, the second signal generated upon input from the user and transmitted to at least a first output device in a remote location;
an authentication component operative to acknowledge the second signal received by the first output device, and
a second database component operative to receive and maintain identifying authentication and transmittal information generated by the authentication component, the portable electronic device and/or the first output device.

2. The automated information transmittal and notification system of claim 1, wherein the first output device comprises a printer, a computer, a light source, or a wireless handheld device.

3. The automated information transmittal and notification system of claim 1, wherein
the portable electronic device transmitter component is operative to transmit a third signal from the portable electronic device, the third signal generated upon input by the user and transmitted to a second output device,
the authentication component is operative to acknowledge the third signal received by the second output device, and
the automated information transmittal and notification system further comprises a third database component operative to receive and maintain identifying authentication and transmittal information generated by the authentication component, the portable electronic device and/or the second output device.

4. The automated information transmittal and notification system of claim 3, wherein the first output device receiving the second signal comprises a computer, printer, or wireless handheld device and the second output device receiving the third signal comprises a visual or audio indicator.

5. The automated information transmittal and notification system of claim 4, wherein the first output device comprises a printer.

6. The automated information transmittal and notification system of claim 5, wherein the second output device comprises a visual indicator comprising a light source.

7. The automated information transmittal system and notification of claim 1, wherein the authentication component comprises a radio frequency transmitter and receiver.

8. The automated information transmittal and notification system of claim 3, wherein the authentication component comprises a radio frequency transmitter and receiver, wherein the radio frequency transmitter is housed in an ID card and the radio frequency receiver is proximate to at least one of the output devices.

9. The automated information transmittal and notification system of claim 1, wherein the authentication component comprises a biometric device.

10. The automated information transmittal and notification system of claim 3, wherein the authentication component comprises a biometric device.

11. The automated information transmittal and notification system of claim 1 wherein the at least one medical data parameter is a medical laboratory result and the remote location is a health care facility.

12. An automated transmittal and notification system for medical events comprising
a primary database component for receiving at least one medical event from a remote facility;
a processor for scanning the primary database component for the medical event and comparing the medical event to a preconfigured set of logic decisions;
a primary transmittal component operative to transmit a primary signal to a portable electronic device depending on a satisfactory relationship between the medical event and the preconfigured set of logic instructions, the primary signal directing a health care professional observing the portable electronic device to a remote application on the portable electronic device where the health care professional may interpret the medical event;
a portable electronic device transmittal component operative to transmit at least a secondary signal generated upon input from the health care professional from the portable electronic device to at least a first output device in a health care facility;
an authentication component operative to indicate that a health care provider in the health care facility has received the secondary signal; and
a secondary database component operative to store at least one record of the authentication of the secondary signal and transmission of the medical event generated by the authentication component, the portable electronic device and/or the first output device.

13. The automated transmittal and notification system of claim 12, wherein the first output device comprises a printer, a computer, a light source, or a wireless handheld device.

14. The automated transmittal and notification system of claim 12, wherein
the first output device comprises a printer,
the portable electronic device transmittal component is further operative to transmit a tertiary signal generated upon input from the health care professional from the portable electronic device to a second output device comprising a light source in a health care facility,
the authentication component is operative to indicate that the health care provider in the health care facility has received the tertiary signal, wherein the authentication component deactivates a light in the light source activated by the tertiary signal, and
the automated transmittal and notification system further comprises a tertiary database component operative to store at least one record of the authentication of the tertiary signal and transmission of the medical event generated by the authentication component, the portable electronic device and/or the second output.

15. The automated transmittal and notification system of claim 12 wherein the authentication component comprises a radio frequency transmitter and receiver.

16. The automated transmittal and notification system of claim 14 wherein the authentication component comprises a radio frequency transmitter and receiver, wherein the radio frequency transmitter is housed in an ID card and the radio frequency receiver is proximate to the light box.

17. The automated transmittal and notification system of claim 12 wherein the authentication component comprises a biometric device.

18. The automated transmittal and notification system of claim 14 wherein the authentication component comprises a biometric device.

19. A computerized method for transmitting information and the authentication of the transmission of information, the method comprising:
receiving at least one medical data parameter from at least one remote medical facility;
storing the medical data parameter in a first database component;
comparing the medical data parameter to a preconfigured set of instructions;
transmitting a first signal to a portable electronic device if the medical data parameter satisfies the preconfigured set of instructions, the first signal when received by the portable electronic device providing an access point to a remote application, whereby a user of the portable electronic device may review the medical data parameter;
transmitting at least a second signal from the portable electronic device, the second signal generated upon input from the user of the portable electronic device and transmitted to at least a first output device;
authenticating by an authentication component the reception of the second signal by the first output device; and
storing in a second database component the authentication and transmittal information generated by the authentication component, the portable electronic device and/or the first output device, whereby the authentication and transmittal information may be reviewed to ensure proper transmission of the transmittal information.

20. The computerized method of claim 19, wherein the first output device comprises a printer, a computer, a light source, or a wireless handheld device.

21. The computerized method of claim 19 further comprising
transmitting a third signal from the portable electronic device, the third signal generated upon input from the user of the portable electronic device and transmitted to a second output device;
authenticating by an authentication component the reception of the third signal by the second output device; and
storing in a third database component the authentication and transmittal information generated by the authentication component, the portable electronic device and/or the second output device.

22. The computerized method according to claim 21, wherein the first output device receiving the second signal comprises a computer, printer, or wireless handheld device and the second output device receiving the third signal comprises a visual or audio indicator a computer, printer, or wireless handheld device.

23. The computerized method according to claim 22, wherein the first output device comprises a printer.

24. The computerized method according to claim 23 wherein the second output comprises a visual indicator comprising a light source.

25. The computerized method according to claim 19, wherein the authentication component comprises a radio frequency transmitter and receiver.

26. The computerized method according to claim 21, wherein the authentication component comprises a radio frequency transmitter and receiver, wherein the radio frequency transmitter is housed in an ID card and the radio frequency receiver is proximate to at least one of the output devices.

27. The computerized method of claim 19, wherein the wherein the authentication component comprises a biometric device.

28. The computerized method of claim 21, wherein the authentication component comprises a biometric device.

29. The computerized method of claim 19 wherein the at least one medical data parameter is a medical laboratory test result and the remote medical facility location is a medical laboratory.
